(19) United States
(12) Patent Application Publication
(10) Pub. No.: US 2004/0224718 A1
(43) Pub. Date: Nov. 11, 2004

(54) Multifunctional body/motion signal receiving and display device

(76) Inventor: Yu Yu Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/434,191

(22) Filed: May 9, 2003

(51) Int. Cl. H04M 1/00

(52) U.S. Cl. 455/553.1; 455/550.1

(57) ABSTRACT

A multifunctional body/motion signal receiving and display device includes a wireless receiving and display unit that includes at least two carrier frequency receiving channels. At least one first-type transmitting unit, each of which is adapted to emit a series of wireless signals in correspondence to the body signal on a first carrier frequency. At one second-type transmitting unit, each of which is adapted to emit a series of wireless signals in correspondence to the motion signal on a second carrier frequency that is different from the first carrier frequency. The wireless receiving and display unit is adapted to simultaneously receive the wireless signal emitted from the first-type transmitting unit on the first carrier frequency through the first carrier frequency receiving channel and receive the wireless signal emitted from the second-type transmitting unit on the second carrier frequency through the second carrier frequency receiving channel.

### BACKGROUND OF THE INVENTION

1. Field of the Invention

The present invention relates to a body/motion signal receiving and display device, and more particularly to a multifunctional body/motion signal receiving and display device that matches the requirements of users and is cost-effective.

2. Description of the Prior Art

There are variety of body building devices and exercisers developed for people who live in the busy modern commercial society and require appropriate exercises. For a person to accurately control an actual quantity of exercise and moderate personal physical condition, various types of body/motion signal sensing devices have been researched and developed.

Most conventional body signal sensing devices or motion signal sensing devices are designed to provide one single detecting and sensing function. That is, each type of conventional sensing device can detect and sense only one type of signal at a time. The following are some currently frequently used body signal sensing devices or motion signal sensing devices:

1. Wireless Heartbeat-sensing Device: As shown in FIG. 1, a conventional wireless heartbeat-sensing device is used to sense heartbeat or pulse signals from a user's body 1. The wireless heartbeat-sensing device includes a heartbeat detecting and transmitting unit 21 for fitting on the user's chest, and a wrist-type receiving and display unit 22 for fitting around the user's wrist. The heartbeat detecting and transmitting unit 21 detects the user's heartbeats and emits signals representing the heartbeats on a certain carrier frequency. The wrist-type receiving and display unit 22 receives and displays the heartbeat signals emitted from the heartbeat detecting and transmitting unit 21. This type of sensing device is adapted only to receive data of the user's heartbeat frequency.

2. Pedometer; As shown in FIG. 2, a conventional pedometer 3 is bound to a user's body 1 to detect and count an accumulated number of paces the user has advanced. This type of sensing device is adapted only to receive data of the accumulated number of the user's paces.

3. Satellite Positioning Jog-speed Sensing Device: As shown in FIG. 3, a conventional satellite positioning jog-speed sensing device includes a jog-speed sensing unit 41 for fitting on a wrist of a user 1, and a Global Positioning System (GPS) receiving unit 42 for fitting on the user's arm. The GPS receiving unit 42 measures the user's jogging speed and bearings, and sends the measured data to a display on the jog-speed processing and displaying unit 41. This type of sensing device is adapted only to receive data of the user's moving speed and distance or bearings.

4. Wireless Jog-speed Sensing Device; As shown in FIG. 4, a conventional wireless jog-speed sensing device includes a jog-speed sensing unit 51 for fitting on a user's one sports shoe, and a wristwatch-type signal receiving unit 52 for fitting on the user's one wrist. The jog-speed sensing unit 51 detects an accumulated number of the user's paces when the user is jogging, and emits a frequency signal to the signal receiving unit 52, so that the user's jogging speed may be measured. This type of sensing device is adapted only to receive data of the user's moving speed.

5. Bicycle-speed Sensing Device: As shown in FIG. 5, a conventional bicycle-speed sensing device includes a wheel-speed sensing unit 71 for mounting on a front fork of a bicycle 6, and a bicycle-speed meter 72 for fixing to a handlebar of the bicycle 6. The wheel-speed sensing unit 71 detects a moving speed of the bicycle 6 and sends a signal representing the detected moving speed via a wire 73 to the bicycle-speed meter 72, so as to display the moving speed of the bicycle 6. This type of sensing device is adapted only to receive data of the moving speed of the bicycle.

6. Wireless Bicycle-speed Sensing Device: As shown in FIG. 6, a conventional wireless bicycle-speed sensing device includes a wireless wheel-speed sensing unit 81 for mounting on a front fork of a bicycle 6, and a wireless signal receiving and display unit 82 for fixing to a handlebar of the bicycle 6. The wheel-speed sensing unit 81 detects a moving speed of the bicycle 6 and transmits the detected wheel speed via a radio frequency to the wireless signal receiving and display unit 82. This type of sensing device is adapted only to receive data of the moving speed of the bicycle 6.

All of the aforesaid conventional body signal sensing device and motion signal sensing devices are designed to have only one detecting and sensing function. That is, in practical use of these conventional sensing devices, they can detect and display only one type of signal. If it is desired to change the conventional body signal sensing devices or motion signal sensing devices into a multifunctional device, there must be transmitting circuit and receiving circuit or coded circuit designed for more than one channels. This would result in the following drawbacks:

1. The design including too many different carrier channels would result in increased production cost.

2. The circuits are highly complicated, may consume a large volume of power, and could not be easily produced.

3. The sensing devices tend to mutually interfere with one another and/or interfere with other devices.

4. The product would be large in size.

5. The multifunctional sensing devices provide complicate functions and are not easily operable.

6. The coded circuit has very high carrier frequency to produce radiated waves that are harmful to human body.

7. Coded circuit or coded integral circuit is required in the multifunctional sensing device that results in high costs for components and elements.

8. With the coded circuit design, parity is required in production of the devices, which results in difficulties in production and customer service.

Therefore, it is necessary to develop a multifunctional body/motion signal receiving and display device to eliminate the above-mentioned drawbacks.

### SUMMARY OF THE INVENTION

A primary object of the present invention is to provide a multifunctional body/motion signal receiving and display device that is developed based on the requirements of exercisers and thorough studies on the uses of various body/motion signal receiving and display device by different types of exercisers. The device of the present invention is in the form of a wrist-type device with liquid crystal display, and is economical and very suitable for all users.

Another object of the present invention is to provide a body/motion signal receiving and display device which can provide audio. It enables the user to enjoy to his favorite music that can enhance the pleasure of exercise.

To achieve the above and other objects, the technical means adopted by the present invention include the provision of a multi-channel receiving unit having at least two carrier receiving channels. The multi-channel receiving unit is able to simultaneously receive a first carrier frequency wireless signal emitted from at least one first-type transmitting unit and a second carrier frequency wireless signal emitted from at least one second-type transmitting unit. All the first-type transmitting units use the same first carrier frequency, and all the second-type transmitting units use the same second carrier frequency. The second carrier frequency is different the first carrier frequency. The first-type transmitting unit is a heartbeat sensor for detecting a user's heartbeat or pulse signal, while the second-type transmitting unit may be a bicycle moving speed sensing device or a pedometer.

Since it is developed to match the requirements of exercisers and to fit the features of various exercising devices, the multifunctional body/motion signal receiving and display device of the present invention is economical and very suitable for most people being interested in body building. In the whole circuit configuration for the device of the present invention, only two carrier frequencies are used. It eliminates the use of some components and thereby reduces the production costs, renders low complexity in circuit design and low power consumption, enables simple and fast manufacture, reduces mutual interference between signals, and makes the device very compact for carrying and easy for operation. It is therefore superior to the conventional similar products.

### BRIEF DESCRIPTION OF THE DRAWINGS

The present invention will be apparent to those skilled in the art by reading the following description of the best mode and a preferred embodiment of a device for carrying out the present invention, with reference to the attached drawings, in which:

FIG. 1 schematically shows the fitting of a conventional wireless heartbeat-sensing device on a user's body;

FIG. 2 schematically shows the fitting of a conventional pedometer on a user's body;

FIG. 3 schematically shows the fitting of a conventional satellite positioning jog-speed sensing device on a user's body;

FIG. 4 schematically shows the fitting of a conventional wireless jog-speed sensing device on a user's body;

FIG. 5 schematically shows the mounting of a conventional bicycle-speed sensing device on a bicycle;

FIG. 6 schematically shows the mounting of a conventional wireless bicycle-speed sensing device on a bicycle;

FIG. 7 is a block diagram showing a circuitry for a wireless heartbeat-sensing unit forming part of the present invention;

FIG. 8 is a block diagram showing a circuitry for a wireless speed-sensing device forming part of the present invention;

FIG. 9 is a block diagram showing a circuitry for a wireless pedometer forming part of the present invention;

FIG. 10 is a block diagram showing a circuitry for a wireless receiving and display unit according to a first embodiment of the present invention;

FIG. 11 is a block diagram showing a circuitry for a wireless receiving/display unit according to a second embodiment of the present invention;

FIG. 12 is a block diagram showing a circuitry of a receiving/display unit according to a third embodiment of the present invention that provides audio via wire transmission;

FIG. 13 is a block diagram showing a circuitry of a receiving/display unit according to a third embodiment of the present invention that provides audio by wireless transmission;

FIG. 14 schematically shows that a user puts on a wire earphone which is connected via a wire to the body/motion signal receiving and display device of the present invention for receiving audio therefrom;

FIG. 15 schematically shows that the fitting of the body/motion signal receiving and display device of FIG. 14 to the waist of the user; and

FIG. 16 schematically shows that a user puts on a wireless earphone for receiving audio wirelessly from the body/motion signal receiving and display device of the present invention.

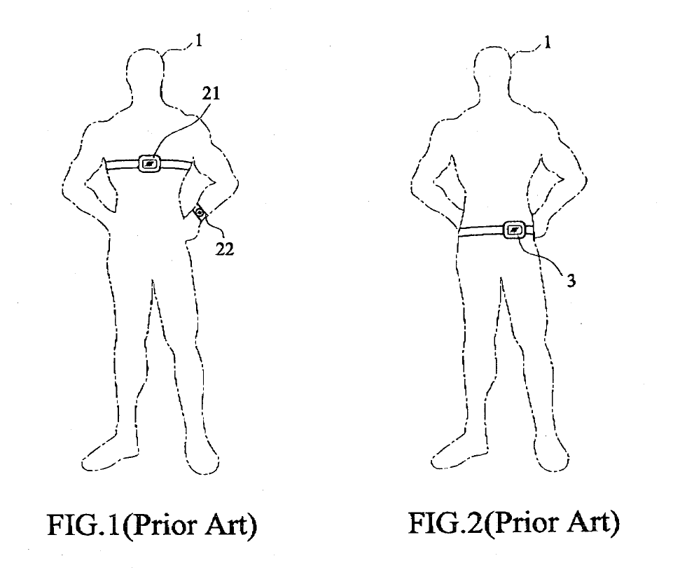

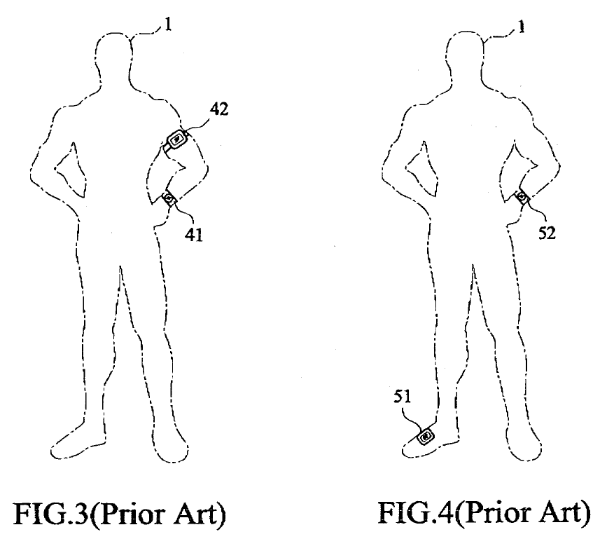

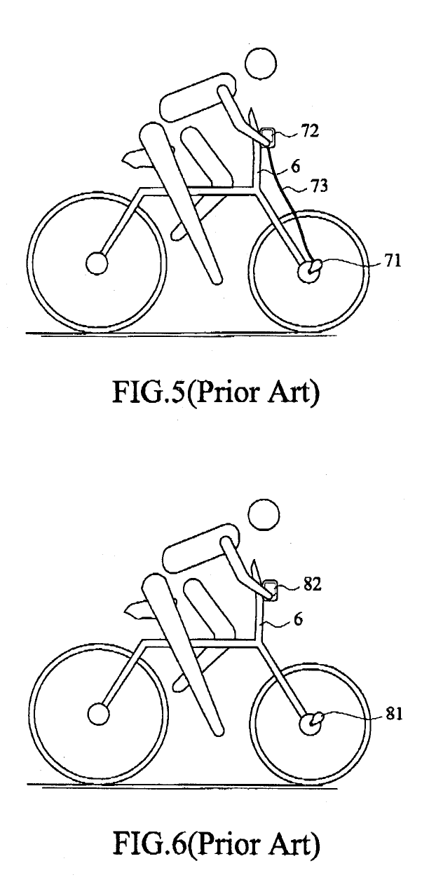

### DETAILED DESCRIPTION OF THE PREFERRED EMBODIMENTS

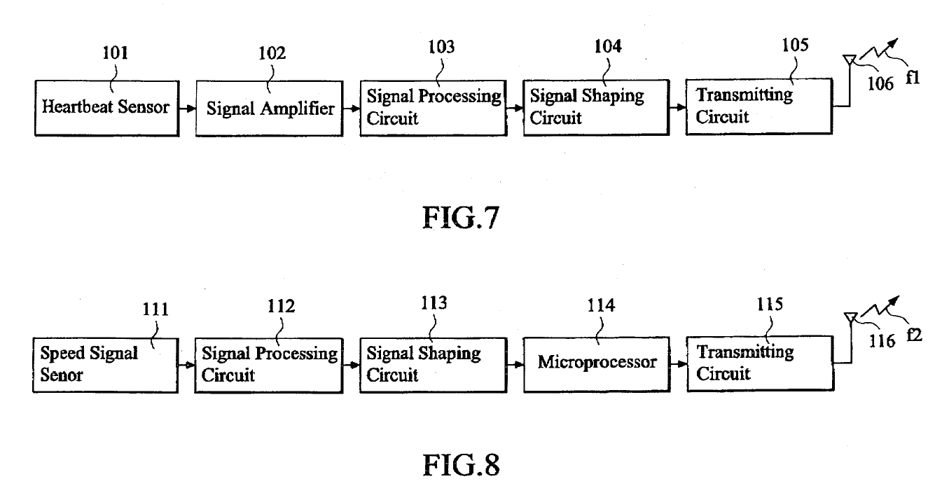

Please refer to FIG. 7 that is a block diagram showing a circuitry for a wireless heartbeat-sensing device forming part of the present invention. As shown, the circuitry includes a heartbeat sensor 101, a signal amplifier 102, a signal processing circuit 103, a signal shaping circuit 104, a transmitting circuit 105, and a transmitting antenna 106, The heartbeat sensor 101 detects and senses a user's heartbeat pulse signal. The detected heartbeat pulse signal is amplified by the signal amplifier 102, and then processed by the signal processing circuit 103 and shaped by the signal shaping circuit 104. Finally, the signal representing the user's heartbeat pulse is emitted on a first carrier frequency f1 by the transmitting circuit 105 via the transmitting antenna 106.

FIG. 8 is a block diagram showing a circuitry for a wireless speed-sensing device forming part of the present invention. As shown, the circuitry includes a speed signal sensor 111, a signal processing circuit 112, a signal shaping circuit 113, a microprocessor 114, and a transmitting circuit 115. The speed signal sensor 111 detects and senses a moving speed of a bicycle. The detected speed signal is processed by the signal processing circuit 112 and shaped by the signal shaping circuit 113 before being sent to the microprocessor 114, at where the processed and shaped signal is calculated. Finally, the signal representing the bicycle speed is emitted on a second carrier frequency f2 by the transmitting circuit 115 via a transmitting antenna 116. In other embodiments of the present invention, the speed-sensing device may be a wired bicycle speed sensing device, or other sensing devices for detecting and sensing speed, such as, a satellite positioning jog-speed sensing device, a wireless jog-speed sensing device, etc.

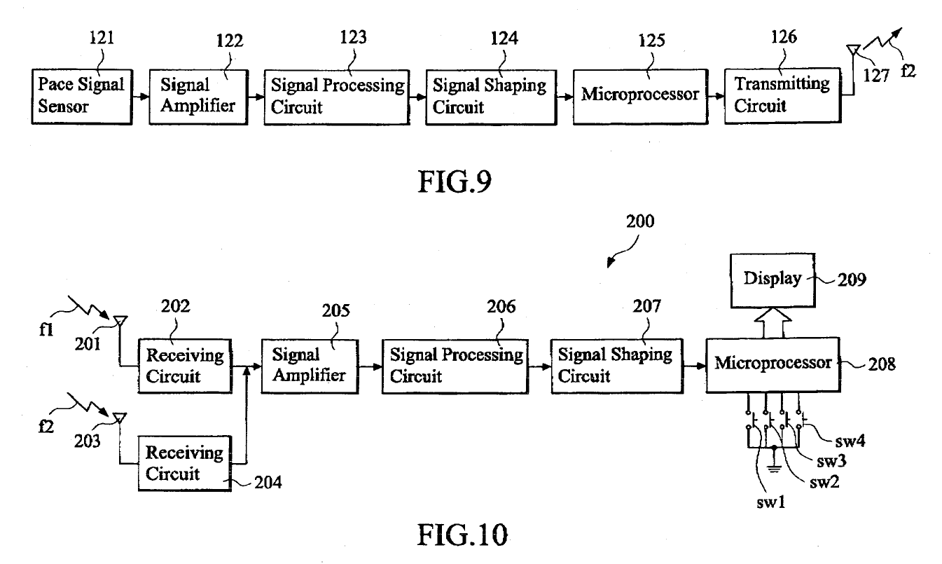

FIG. 9 is a block diagram showing a circuitry for a wireless pedometer forming part of the present invention. As shown, the circuitry includes a pace signal sensor 121, a signal amplifier 122, a signal processing circuit 123, a signal shaping circuit 124, a microprocessor 125, and a transmitting circuit 126. The pace signal sensor 121 detects and senses an accumulated number of paces of a walker. The detected pace number signal is amplified by the signal amplifier 122, processed by the signal processing circuit 123, and shaped by the signal shaping circuit 124 before being sent to the microprocessor 125, at where the signal is calculated. Finally, a signal representing the number of paces is emitted on a second carrier frequency f2 by the transmitting circuit 126 via a transmitting antenna 127.

FIG. 10 is a block diagram showing a circuitry for a wireless receiving and display unit 200 according to a first embodiment of the present invention. As shown, the circuitry includes a first receiving antenna 201, a first receiving circuit 202, a second receiving antenna 203, a second receiving circuit 204, a signal amplifier 205, a signal processing circuit 206, a signal shaping circuit 207, a microprocessor 208, and a display 209. The first receiving circuit 202 is adapted to receive via the first receiving antenna 201 a signal emitted from the wireless heartbeat-sensing device of FIG. 7 on the first carrier frequency f1, and the second receiving circuit 204 is adapted to receive via the second receiving antenna 203 a signal emitted from the speed-sensing device of FIG. 8 on the second carrier frequency f2, or a signal emitted from the wireless pedometer of FIG. 9 on the second carrier frequency f2.

The received signals on the first and the second carrier frequency f1, f2 are amplified by the signal amplifier 205, processed by the signal processing circuit 206, and shaped by the signal shaping circuit 207 before they are sent to the microprocessor 208. The signal is then calculated at the microprocessor 208 and shown at the display 209.

The wireless receiving and display unit for the present invention may also include a plurality of control switches, for example, sw1 through sw4, for providing different manual control functions, such as a mode select switch, a value set switch, a start switch, and a reset switch.

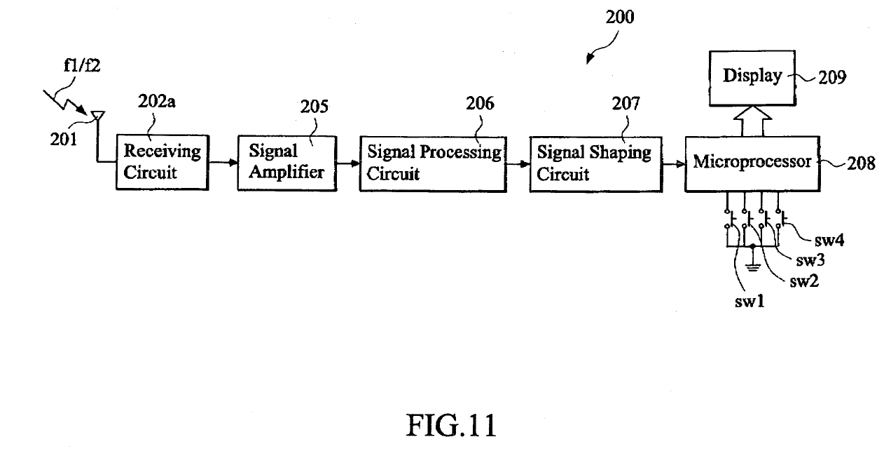

FIG. 11 is a block diagram showing a circuitry for a wireless receiving/display unit according to a second embodiment of the present invention. As shown, the circuitry in the second embodiment is similar to that in the first embodiment of FIG. 10, except that it includes only one common receiving antenna 201 for receiving both signals on the first and the second carrier frequency f1, f2, and one common receiving circuit 202a that is internally provided with two groups of different signal coils for separately receiving the signals on the first and the second carrier frequency f1, f2, The other parts of the wireless receiving/display unit including the signal amplifier 205, the signal processing circuit 206, the signal shaping circuit 207, the microprocessor 208, and the display 209 are identical to those shown in FIG. 10.

With the above arrangements, when a user takes exercise by riding a bicycle, the speed-sensing unit of FIG. 8 may be used to detect the moving speed of the bicycle. When the same user puts on the wireless heartbeat-sensing unit of FIG. 7 at the same time, the wireless receiving and display unit of the present invention of FIG. 10 or 11 would enable the user to observe his or her heartbeat frequency while riding the bicycle. What is more interesting is, when the user completes the bicycle riding and proceeds with jogging or walking, etc., the wireless receiving and display unit of the present invention also functions to receive and display data about the user's moving speed, an accumulated number of paces within a certain time period, etc. In brief, the present invention provides a multifunctional body/motion signal receiving and display device.

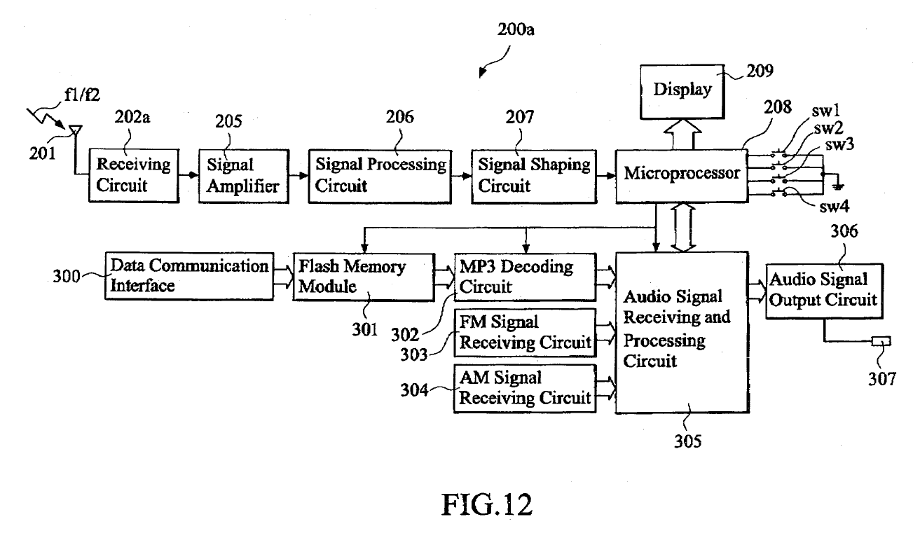

Preferably, the present invention is provided with an audio device and enables the user to listen to music at exercise. Please refer to FIG. 12 which shows a circuitry of a wireless receiving/display unit 200a according to a third embodiment the present invention. The wireless receiving/display unit 200a comprises an audio source device which includes a flash memory module 301, a MP3 decoding circuit 302, a FM signal receiving circuit 303 and an AM signal receiving circuit 304. The flash memory module 301 can download sound data from a computer via a data communication interface 300, e.g. a standard USB interface or RS232 interface. The sound data can be stored in the form of MP3 or any other formats such as WMA. The other parts of the receiving/display unit 200a are identical to those shown in FIG. 11.

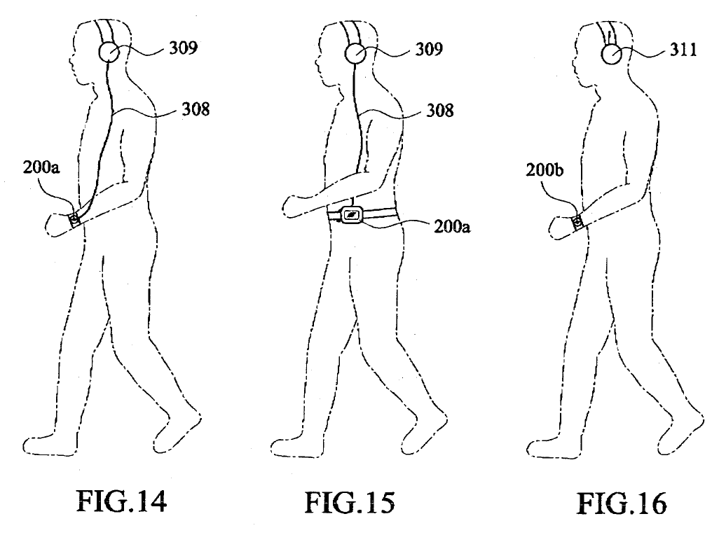

The MP3 sound data stored in flash memory module 301 is sent to and decoded by the MP3 decoding circuit 302. The decoded signal is then processed by the audio signal receiving and processing circuit 305 and sent to an audio signal output circuit 306. The signal is transmitted to the earphone 309 of user via the audio output terminal 307 and a wire 308 plugged to the audio output terminal 307. Thereby, the user can listen to music transmitted to his earphone 309 as shown in FIGS. 14 and 15. Similarly, the audio signal received by the FM signal receiving circuit 303 or AM signal receiving circuit 304 is sent to and processed by the audio signal receiving and processing circuit 305 and sent out by the audio signal output circuit 306.

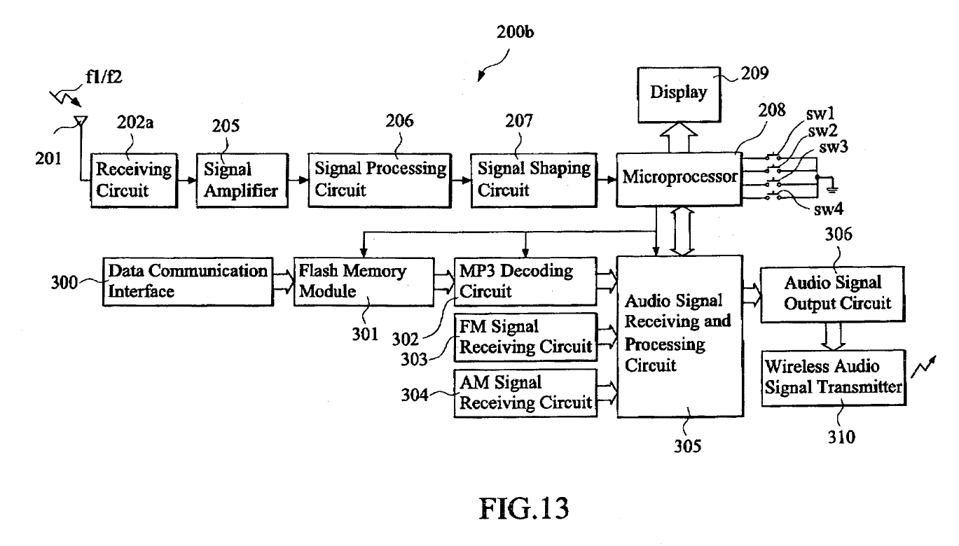

FIG. 13 shows a circuitry of a receiving/display unit 200b according to a fourth embodiment the present invention that provides audio by wireless transmission. The circuitry is substantially identical to that of FIG. 12, except that the audio signal is transmitted by wireless transmission. The audio signal from the MP3 decoding circuit 302, FM signal receiving circuit 303 or AM signal receiving circuit 304 is processed by the audio signal receiving and processing circuit 305 and sent to the audio signal output circuit 306. The audio signal is then transmitted via a wireless audio signal transmitter 310 to a wireless earphone 311, as shown in FIG. 16.

With the embodiments described above, it is understood that the present invention provides an economical and multifunctional body/motion signal receiving and display device, which matches the various requirements of users. The different body/motion signals can be transmitted by means of the two carrier frequencies used in the circuitry. Accordingly, it minimizes the components used, production costs, the power consumption and the product size, simplifies the circuit design and manufacture processes, reduces the mutual interference between signals, and makes the device easy for operation. As a whole, it is practical for use and superior to similar product available in the market.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A device for receiving and displaying at least a body signal and a motion signal of a user, comprising:
a wireless receiving and display unit with at least a first carrier frequency receiving channel and a second carrier frequency receiving channels;
at least one first-type transmitting unit, each of which is adapted to emit a series of wireless signals in correspondence to the body signal on a first carrier frequency; and
at least one second-type transmitting unit, each of which is adapted to emit a series of wireless signals in correspondence to the motion signal on a second carrier frequency that is different from the first carrier frequency; and
the wireless receiving and display unit being adapted to simultaneously receive the wireless signal emitted from the first-type transmitting unit on the first carrier frequency through the first carrier frequency receiving channel and receive the wireless signal emitted from the second-type transmitting unit on the second carrier frequency through the second carrier frequency receiving channel.

2. The device as claimed in claim 1, wherein the first-type transmitting unit comprises a wireless heartbeat-sensing device for detecting and sensing a heartbeat pulse signal of the user.

3. The device as claimed in claim 2, wherein the wireless heartbeat-sensing device comprises a heartbeat sensor, a signal amplifier, a signal processing circuit, a signal shaping circuit, a transmitting circuit and a transmitting antenna, the user's heartbeat pulse signal being detected and sensed by the heartbeat sensor, amplified by the signal amplifier, processed by the signal processing circuit, shaped by the signal shaping circuit and then transmitted on the first carrier frequency by the transmitting circuit via the transmitting antenna.

4. The device as claimed in claim 1, wherein the second-type transmitting unit comprises a wireless speed-sensing device for detecting and sensing a moving speed of a bicycle or a person.

5. The device as claimed in claim 4, wherein the wireless speed-sensing device comprises a speed signal sensor, a signal processing circuit, a signal shaping circuit, a microprocessor and a transmitting circuit, a moving speed of a bicycle being detected by the speed signal sensor, processed by the signal processing circuit, shaped by the signal shaping circuit, calculated at the microprocessor, and then emitted on the second carrier frequency by the transmitting circuit via a transmitting antenna.

6. The device as claimed in claim 1, wherein the second-type transmitting unit comprises a pedometer for detecting and sensing an accumulated number of paces of the user.

7. The device as claimed in claim 6, wherein the pedometer comprises a pace signal sensor, a signal amplifier, a signal processing circuit, a signal shaping circuit, a microprocessor, and a transmitting circuit, an accumulated number of paces of a walker being detected and sensed by the pace signal sensor, amplified by the signal amplifier processed by the signal processing circuit, shaped by the signal shaping circuit, calculated at the microprocessor, and then emitted on the second carrier frequency by the transmitting circuit via a transmitting antenna.

8. The device as claimed in claim 1, wherein the wireless receiving and display unit comprises at least one receiving antenna, at least one receiving circuit, a signal amplifier, a signal processing circuit, a signal shaping circuit, a microprocessor, and a display, the signal on the first carrier frequency from the first-type transmitting unit and the signal on the second carrier frequency from the second-type transmitting unit being received by the receiving antenna, amplified by the signal amplifier, processed by the signal processing circuit, shaped by the signal shaping circuit, calculated at the microprocessor and then shown on the display.

9. The device as claimed in claim 1, which further comprises;
an audio device;
an audio signal receiving and processing circuit for receiving and processing an audio signal generated by the audio device; and
an audio signal output circuit for outputting the processed audio signal transmitted from the audio signal receiving and processing circuit.

10. The device as claimed in claim 9, wherein the audio device comprises a flash memory module and a MP3 decoding circuit, in which a sound data is stored in the flash memory module, decoded by the MP3 decoding circuit and then sent to the audio signal receiving and processing circuit.

11. The device as claimed in claim 9, wherein the audio source device comprises a FM signal receiving circuit.

12. The device as claimed in claim 9, wherein the audio source device comprises an AM signal receiving circuit.

13. The device as claimed in claim 9, wherein the audio signal from the audio signal output circuit is transmitted to a wired earphone via an audio output terminal and a wire plugged to the audio output terminal.

14. The device as claimed in claim 9, wherein the audio signal from the audio signal output circuit is sent to and emitted by a wireless audio signal transmitter to a wireless earphone.
